(19) United States
(12) Patent Application Publication
(10) Pub. No.: US 2013/0126240 A1
(43) Pub. Date: May 23, 2013

(54) METHOD FOR SALT AND CROSS-BED PROXIMITY DETECTION USING DEEP DIRECTIONAL ELECTROMAGNETIC MEASUREMENTS WHILE DRILLING

(71) Applicants: Lucian Johnston, Sugar Land, TX (US); Andrew Hawthorn, Missouri City, TX (US)

(72) Inventors: Lucian Johnston, Sugar Land, TX (US); Andrew Hawthorn, Missouri City, TX (US)

(73) Assignee: Schlumberger Technology Corporation, Sugar Land, TX (US)

(21) Appl. No.: 13/698,601

(22) PCT Filed: May 18, 2011
(86) PCT No.: PCT/US11/37042

§ 371 Date: Feb. 1, 2013

Related U.S. Application Data
(60) Provisional application No. 61/347,771, filed on May 24, 2010.

(51) Int. Cl. G01V 3/34; E21B 7/04; G01V 3/30

(52) U.S. Cl. CPC G01V 3/34; G01V 3/30; E21B 7/04
USPC 175/45; 702/7; 324/339

(57) ABSTRACT

A method for drilling a wellbore proximate a salt structure includes measuring formation resistivity azimuthally. A map of spatial distribution of resistivity is determined from the azimuthal resistivity measurements. A distance from the wellbore to an edge of the salt structure is determined from the three dimensional volume map.

### CROSS-REFERENCE TO RELATED APPLICATIONS

Priority is claimed from U.S. Provisional Application No. 61/347,771 filed on May 24, 2010.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of directional wellbore drilling using electromagnetic conductivity measurements of rock formations to guide wellbore trajectory. More specifically, the invention relates to methods for using such measurements while drilling through crossbedding (near-perpendicular or at low angles to planes of formations) where formations may be laterally terminated by structures such as salt bodies or salt diapirs.

2. Background Art

The detection of a salt feature and measuring the proximity of the salt feature to a borehole is well known in the art. An early method of detecting a salt feature from a borehole is described in U.S. Pat. No. 3,256,480 issued to Runge et al. The described method in the Runge et al. '480 patent used basic electrical borehole logging measurements and inferred the salt feature location by comparing the resistivity of the earth formation close to the borehole with the resistivity from far away from the borehole. The measurements at long distances from the borehole were obtained with the same basic resistivity method but using very long spaced electrodes. The foregoing method was commercialized by Schlumberger Technology Corporation in the 1960's under the trade name ULSEL (Ultra Long Spaced Electrical Logging). The primary use for the method was to locate the sides of salt domes, which frequently act as traps for hydrocarbons in formations adjacent to the salt dome. The ULSEL tool consists of four to six long normal arrays with spacings ranging from 75 to 2400 feet. The depth of investigation of ULSEL is approximately 2000 feet from the wellbore. See, for example, Anderson, B. I., Modeling and Inversion Methods for the Interpretation of Resistivity Logging Tool Response, DUP Science, Delft, The Netherlands, 2001.

The ULSEL method involves using a specialized resistivity tool lowered into an existing borehole using an armored electrical cable (“wireline”). After determining if a salt interface is close to that borehole, the tool and cable were removed and the borehole was either completed or drilling continued. It is also known in the art that similar methods can also be used when the borehole is located within the salt body. See, William T. Holser et. al., U.S. Pat. No. 3,286,163.

Another method used in the industry to detect the proximity of a salt feature to a borehole is seismic waves as described in Akkas Manzur et al., U.S. Pat. No. 5,170,377. As described in the Manzur et al. patent, seismic waves from a source located over the top of a salt feature are received by a seismic sensor located in a tool within the borehole. The distance between the seismic sensor and the salt feature can be interpreted by modeling the salt and formation velocities and comparing the modeled transit times to the actual transit times of refracted waves from the seismic source to the seismic sensor. The process is repeated by changing the modeled distance from the borehole to the salt until the transit times agree.

It is also known in the art that reflected seismic waves can be used from sources located on the surface or within a borehole to interpret the distance from borehole-located seismic receivers to the salt feature.

Mark E. Ander, U.S. Pat. No. 7,069,780, describes using gravity methods for mapping gravity contrast from a borehole. The '780 patent also discusses using the same technique on wireline or while drilling.

Tarek M. Habashy et al., U.S. Pat. No. 5,530,359 describes a while-drilling electromagnetic measurement system and its use in detecting subsurface structures through which a borehole is drilled. The Habashy et al. '359 patent does not specifically describe or claim an application related to the interface between a salt feature and some other type of geologic formation, nor does it claim an application where the borehole is not drilled through the body to be detected.

### SUMMARY OF THE INVENTION

A method for drilling a wellbore proximate a salt structure according to one aspect of the invention includes measuring formation resistivity azimuthally. A map of spatial distribution of resistivity is determined from the azimuthal resistivity measurements. A distance from the wellbore to an edge of the salt structure is determined from the map.

A system for directional drilling proximate a salt structure according to another aspect of the invention include an azimuthally sensitive resistivity measuring instrument forming part of a drill string. The system includes a communication device for communicating measurements from the resistivity instrument to the surface from within a wellbore. A processor forming part of the system includes therein program instructions to generate a map of resistivity distribution from the resistivity measurements. The processor includes program instructions to calculate a lateral distance from the resistivity measuring instrument to a boundary of a salt structure from the map.

Other aspects and advantages of the invention will be apparent from the following description and the appended claims.

### BRIEF DESCRIPTION OF THE DRAWINGS

FIG. 1 shows an example drilling system including an azimuthally sensitive resistivity measuring logging while drilling (“LWD”) instrument.

FIG. 2 shows an example of using the system of FIG. 1 to maintain a selected distance from a salt structure while drilling a wellbore.

FIG. 3 shows an example of using the system of FIG. 1 to maintain a selected distance to formations from within a salt structure while drilling a wellbore therethrough.

### DETAILED DESCRIPTION

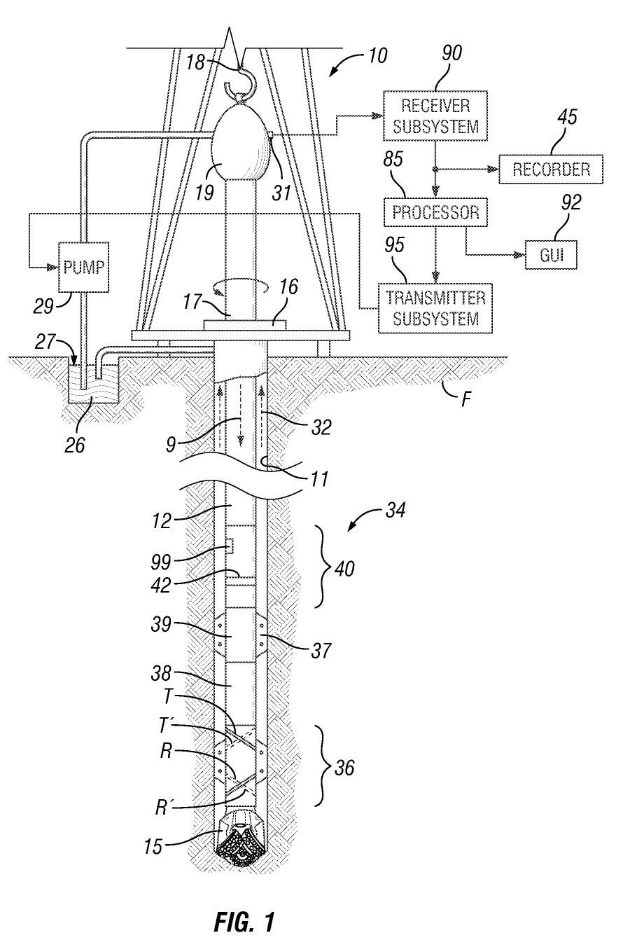

FIG. 1 illustrates a conventional drilling rig and a drill string in which an instrument for performing a method according to the present invention can be used. A land-based platform and derrick assembly 10 are shown positioned over a wellbore 11 penetrating a subsurface rock formation F. In the illustrated example, the wellbore 11 is formed by rotary drilling in a manner that is well known. Those of ordinary skill in the art given the benefit of this disclosure will appreciate, however, that the present invention also finds application in directional drilling, for example, using rotary steerable directional drilling systems or “steerable” hydraulic motors. Further, the invention is not limited to land-based drilling but is equally applicable in marine wellbore drilling.

A drill string 12 is suspended within the wellbore 11 and includes a drill bit 15 at its lower end. The drill string 12 can be rotated by a rotary table 16, energized by means (not shown) which engages a kelly 17 at the upper end of the drill string 12. The drill string 12 is suspended from a hook 18, attached to a traveling block (also not shown), through the kelly 17 and a rotary swivel 19 which permits rotation of the drill string 12 relative to the hook 18.

Drilling fluid or mud 26 is stored in a pit 27 formed at the well site or a tank. A pump 29 delivers the drilling fluid 26 to the interior of the drill string 12 via a port in the swivel 19, inducing the drilling fluid to flow downwardly through the drill string 12 as indicated by the directional arrow 9. The drilling fluid 26 exits the drill string 12 via jets or courses (not shown) in the drill bit 15, and then circulates upwardly through the annular space between the outside of the drill string 12 and the wall of the wellbore 11, (called the “annulus”), as indicated by the direction arrows 32. In this manner, the drilling fluid 26 cools and lubricates the drill bit 15 and carries formation cuttings up to the surface as it is returned to the pit 27 for recirculation.

The drill string 12 further includes a bottom hole assembly, generally shown at 34, near the drill bit 15 (in other words, within several drill collar lengths from the drill bit). The bottom hole assembly 34 includes instruments in the interior of drill collars or similar tubular devices in the drill string 12 having capability for measuring, processing, and storing information, as well as communicating information to and receiving information from the surface. The bottom hole assembly (“BHA”) 34 thus may include, among other devices, a measuring and local communications apparatus 36 for determining and communicating resistivity of the formation F surrounding the wellbore 11. The measuring device and local communications apparatus 36, also known as a “resistivity tool”, includes a first pair of transmitting/receiving antennas T, R, as well as a second pair of transmitting/receiving antennas T″, R″. The second pair of antennas T″, R″ are symmetric with respect to the first pair of antennas T, R, as is described in greater detail below. The resistivity tool 36 further includes a controller (not shown separately) to control the acquisition of data, as is known in the art.

The BHA 34 may further include instruments housed within certain drill collars 38, 39 for performing various other measurement functions, such as measurement of the natural radiation, density (gamma ray or neutron), and pore pressure of the formation F. At least some of the drill collars may be equipped with stabilizers 37, as are well known in the art.

A surface/local communications subassembly 40 may also be included in the BHA 34, just above one of the drill collars shown at 39. The subassembly 40 may include a toroidal antenna 42 used for local communication with the resistivity tool 36 (although other known local-communication means may be used in other examples), and a known type of acoustic telemetry system that communicates with a similar system (not shown) at the earth's surface via signals carried in the drilling fluid or mud. Thus, the telemetry system in the subassembly 40 may include an acoustic transmitter that generates an acoustic signal in the drilling fluid (a.k.a., “mud-pulse”) that is representative of selected parameters measured by the resistivity tool 36 and/or other instruments 38, 39.

The generated acoustical signal may received at the surface by pressure transducers represented by reference numeral 31. The transducers, for example, piezoelectric transducers, convert the received acoustical signals to electrical signals. The output of the transducers 31 may be coupled to a surface receiving subsystem 90, which demodulates the signals detected by the transducers 31. The output of the receiving subsystem 90 may then be coupled to a computer processor 85 and a recorder 45. The computer processor 85 may be used to determine a formation resistivity profile (among other things) on a “real time” basis, that is, while drilling and contemporaneous well logging measurement is underway, or subsequently by accessing recorded data from the recorder 45. The computer processor 85 can be coupled to a monitor 92 that uses a graphical user interface (“GUI”) through which the measured downhole parameters and particular results derived therefrom (e.g., resistivity profiles) are graphically presented to a user.

A surface transmitting system 95 may also be provided for receiving input commands and data from the user (e.g., via the GUI in monitor 92), and is operative to, for example, selectively interrupt the operation of the pump 29 in a manner that is detectable by transducers 99 in the subassembly 40. In this manner, there is two-way communication between the subassembly 40 and the surface equipment. A suitable subassembly 40 is described in greater detail in U.S. Pat. Nos. 5,235,285 and 5,517,464, both of which are assigned to the assignee of the present invention and incorporated herein by reference. Those skilled in the art will appreciate that alternative acoustic techniques, as well as other telemetry means (e.g., electromechanical, electromagnetic), can be used for communication between the surface and the subassembly 40. Other signal communication, such as having the drill string include a “wired” signal communication channel are also within the scope of the present invention. One such communication channel is described in U.S. Pat. No. 6,641,434 issued to Boyle et al., assigned to the assignee of the present invention and incorporated herein by reference.

The resistivity tool shown in and explained above with reference to FIG. 1 makes resistivity measurements that are dependent on the rotational (azimuthal) orientation of the tool with respect to the formations F. The manner of making such azimuthally dependent resistivity measurements is more fully described in U.S. Pat. No. 7,382,135 issued to Li et al., assigned to the assignee of the present invention and incorporated herein by reference. As described in the Li et al. '135 patent, the method of making azimuthally sensitive measurements finds particular application in determining distance to a formation boundary, or a resistivity contrast within a particular formation, e.g., a gas/water or oil/water contact. The method described in the Li et al. '135 patent, when used for such purposes, generally has the condition that the boundaries of resistivity differences are generally parallel to the longitudinal axis of the instrument.

Another while-drilling resistivity measuring instrument that may be used in other examples is described in U.S. Pat. No. 7,775,362 issued to Seydoux et al., assigned to the assignee of the present invention and incorporated herein by reference.

In a method according to the present invention, it is contemplated that the wellbore (11 in FIG. 1) will be drilled such that the boundaries of the rock formations, and thus resistivity contrasts, will generally be perpendicular to the longitudinal axis of the resistivity tool. In specific examples, to be discussed further below, the resistivity tool may be used to estimate the lateral distance between the wellbore and the flank of a salt structure, e.g., a salt diapir during formation drilling. In another example, the wellbore may be drilled through the flank of a salt diaper, and the method may be used to estimate the lateral distance to non-salt formations adjacent to the flank of the salt diapir.

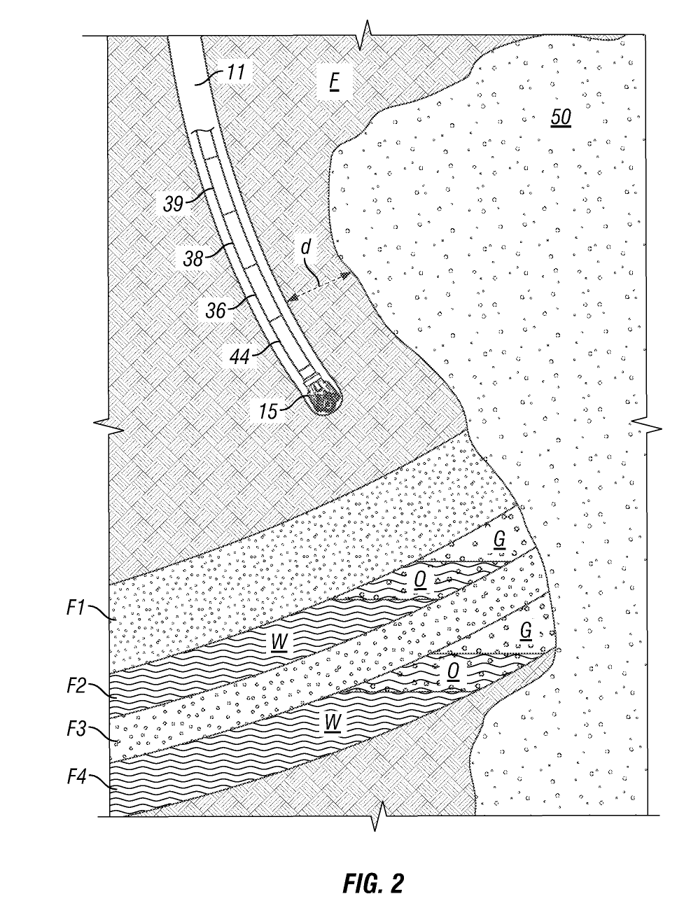

Referring to FIG. 2, the example drilling system of FIG. 1 may be used to drill a wellbore 11 along a selected trajectory at a particular, and in one example, maintain the trajectory at a substantially constant lateral distance from a salt structure 50. Only part of the drilling system is shown in FIG. 2, including the resistivity tool 36 and certain drill collars 38, 39 for clarity of the illustration. In the present example, the drilling system may include a device 44 for selectively controlling the trajectory of the wellbore during drilling. One example of such a device is known as a rotary steerable directional drilling system (“RSS”). One example RSS is used to provide services under the service mark POWERDRIVE, which is a mark of the assignee of the present invention. Other RSS devices may be used, or devices called “steerable motors” may be used in other examples. Typically the RSS 44 is disposed directly above the drill bit 15 in the drill string (12 in FIG. 1) and includes pads or other extensible devices to deflect the path of the bit 15 as it drills through the subsurface rock formations F. The POWERDRIVE RSS is capable of receiving commands from the surface, generated, for example, as explained with reference to FIG. 1, wherein the commands are interpreted in the RSS 44 to change the trajectory of the wellbore 11.

In the present example, the resistivity tool 36 makes azimuthal resistivity measurements, as explained above. The azimuthal resistivity measurements are used as input, for example, to a three dimensional (3D) resistivity inversion modeling program. Output of such program is typically a 3D volume map of the spatial distribution of resistivity. Such 3D volume map may be used to determine the locations of formation boundaries, as well as the lateral distance between the resistivity tool 36 and the salt structure 50. The lateral distance between the resistivity tool 36 and the salt structure is shown by “d” in FIG. 2. One example of 3D volume map generating software is sold by the assignee of the present invention under the trademark PETREL. It is also within the scope of the present invention to generate a two dimensional (2D) map of spatial distribution of resistivity, for example using the PETREL software, and determine the distance d using such two dimensional map of resistivity distribution.

In the present example, the processor (85 in FIG. 1) may continuously operate the inversion program and substantially continuously compute values of d. The computed values of d may be used to adjust the trajectory of the wellbore. For example, the trajectory may be adjusted to maintain a constant value of d. The trajectory may be manually adjusted by the system operator, or may be automatically controlled. In automatic control, the resistivity map may be used in the processor (85 in FIG. 1) to determine a value of d ahead of the drill bit 15 if the wellbore trajectory were maintained constant. If the ahead of bit value of d is larger or smaller than the present value of d, a correction to the trajectory may be calculated in the processor (85 in FIG. 1) and suitable changes to the wellbore trajectory may be computed to cause the value of d to remain substantially constant. Such changes in the trajectory may be communicated to the RSS 44 from the surface using, for example, the surface generated command communication procedure explained with reference to FIG. 1, using the transmitter subsystem 95 to control the pump 29. Other surface to wellbore communication procedures known in the art may also be used.

One possible outcome of maintaining a constant value of d while drilling the wellbore 11 may be observed with reference to certain formations F2 and F4 in FIG. 2, which are laminated along with impermeable formations F1 and F3. As will be appreciated by those skilled in the art, formations penetrated by the creation of a salt structure 50 such as shown in FIG. 2 has the effect of folding upward formations that have been penetrated by the salt structure 50. Because salt is substantially impermeable, the combination of upward folding and local termination of the folded formations F1-F4 by the salt structure 50 has the effect of generating very efficient trapping mechanisms for hydrocarbons. As illustrated in FIG. 2, permeable formations F2 and F4 may, for example, include gas G above oil O above water W. It may be desirable to control the well trajectory so that the wellbore 11 is drilled through the oil bearing O part of the permeable formations (e.g., F2, F4). Such may occur if the value of d is maintained constant. Alternatively, the 3D volume map may be continuously updated to estimate the position of the oil bearing O parts of the formations, and the wellbore trajectory can be correspondingly adjusted.

In other examples, other data (e.g., surface reflection seismic data) may indicate that the distance d should not remain constant, but should follow a selected pattern with respect to depth in order to maximize the likelihood of penetrating formations such as F1 through F4 in the portions thereof most likely to be productive of hydrocarbons. The wellbore trajectory may be manually or automatically adjusted to maintain a selected pattern value of distance d rather than a constant value thereof.

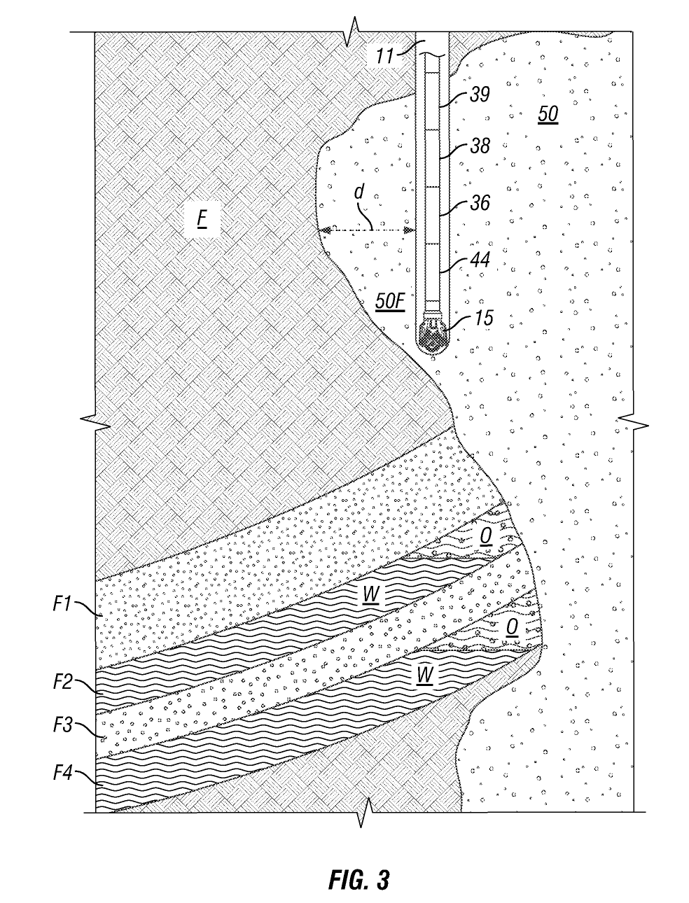

In another example shown in FIG. 3, the wellbore 11 may be drilled through the flank 50F of the salt structure 50 in order to more efficiently drill through the formations disposed below the flank 50F. In such examples, the procedure described with reference to FIG. 2 may be used to determine the distance to the formations F adjacent to the salt structure 50 while the wellbore 11 is drilled through the salt structure 50. The values of d may be used to estimate when the bottom of the flank 50F will be penetrated by the wellbore 11 and which portions of the sub-salt formations F1, F2, F3, F4 should be penetrated to, for example, penetrate oil bearing portions O therein.

Methods and systems according to the invention may provide more efficient wellbore drilling by enabling control of wellbore trajectory to avoid drilling into non-productive formations and increasing the probability of drilling into productive formations when drilling proximate to salt structures.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for drilling a wellbore proximate a salt structure, comprising:
measuring formation resistivity azimuthally;
determining a map of spatial distribution of resistivity from the azimuthal resistivity measurements; and
determining a distance from the wellbore to an edge of the salt structure from the map.

2. The method of claim 1 further comprising: determining the distance at a position along a trajectory of the wellbore and ahead of a position of a drill bit; and adjusting the trajectory of the wellbore so that the distance remains substantially constant.

3. The method of claim 2 wherein the adjusting the trajectory is performed by a rotary steerable directional drilling system.

4. The method of claim 1 further comprising: determining the distance at a position along a trajectory of the wellbore and ahead of a position of a drill bit; and adjusting the trajectory of the wellbore so that the distance follows a selected pattern.

5. The method of claim wherein the measuring resistivity azimuthally comprises:
emitting electromagnetic energy along a direction inclined with respect to a longitudinal axis of a drilling tool;
receiving electromagnetic energy along a direction inclined with respect to the longitudinal axis;
rotating the emitting and receiving directions with respect to the longitudinal axis; and
repeating the emitting and receiving.

6. The method of claim 1 wherein the wellbore is drilled outside and adjacent to the salt structure.

7. The method of claim 1 wherein the wellbore is drilled within the salt structure.

8. A system for directional drilling proximate a salt structure, comprising:
an azimuthally sensitive resistivity measuring instrument forming part of a drill string;
a communication device for communicating measurements from the resistivity instrument to the surface from within a wellbore;
a processor including therein program instructions to generate a map of resistivity distribution from the resistivity measurements, the processor including program instructions to calculate a lateral distance from the resistivity measuring instrument to a boundary of a salt structure from the map.

9. The system of claim 8 further comprising a directional drilling control device and wherein the processor is programmed to determine the lateral distance at a position along a wellbore trajectory and ahead of a drill bit, the processor programmed to communicate instructions to the directional drilling control device to adjust the wellbore trajectory so that the lateral distance remains at least one of substantially constant and along a selected pattern.

10. The system of claim 9 wherein the directional drilling control device comprises a rotary steerable directional drilling system.

11. The system of claim 8 wherein the resistivity measuring instrument comprises:
at least one electromagnetic energy transmitter having a dipole moment along a direction inclined with respect to a longitudinal axis of the instrument;
at least one electromagnetic energy receiver having a magnetic moment along a direction inclined with respect to the longitudinal axis;
means for rotating the at least one transmitter and receiver dipole directions with respect to the longitudinal axis.
